(19) United States
(12) Patent Application Publication
(10) Pub. No.: US 2024/0222056 A1
(43) Pub. Date: Jul. 4, 2024

(54) FUSE, AND METHOD FOR MANUFACTURING A FUSE

(71) Applicant: SIBA Fuses GmbH, Lünen (DE)

(72) Inventors: Andreas Grünig, Lünen (DE); Werner-Günter Schmehl, Iserlohn (DE); Johannes-Georg Gödeke, Lünen (DE)

(73) Assignee: SIBA Fuses GmbH, Lünen (DE)

(21) Appl. No.: 18/258,580

(22) PCT Filed: Sep. 20, 2022
(86) PCT No.: PCT/EP2022/076076

§ 371 Date: Jun. 21, 2023

(30) Foreign Application Priority Data
Sep. 21, 2021 (DE) 10 202 1004 718.4

(51) Int. Cl. H01H 69/02; H01H 85/143; H01H 85/18

(52) U.S. Cl. CPC H01H 69/02; H01H 85/143; H01H 85/18

(57) ABSTRACT

The invention relates to a fuse, in particular SMD fuse and/or miniature fuse, with an insulating body having a cavity, a fusible conductor arranged in the insulating body and outer contact caps placed on the insulating body on the front side and electrically connected to the fusible conductor. According to the invention, the fusible conductor is fixed for positionally stable arrangement in the insulating body by means of at least one fixing means assigned to a contact cap, the fixing means is placed on the front side of the insulating body, and the fixing means is put over at least in regions from the assigned contact cap.

### CROSS-REFERENCE TO RELATED APPLICATIONS

The present application is the U.S. national stage application of international application PCT/EP2022/076076 filed Sep. 20, 2022, which international application was published on Mar. 30, 2023, as International Publication WO 2023/046670. The international application claims priority to German Patent Application No. 10 2021 004 718.4 filed Sep. 21, 2021. The international application and the German application are hereby incorporated herein by reference in their entireties.

### BACKGROUND

The present invention relates to a fuse, in particular an SMD fuse and/or a miniature fuse, with an insulating body having a cavity, a fusible conductor arranged in the insulating body and outer—at least indirect—contact caps placed on the insulating body and electrically connected to the fusible conductor.

A fuse or device protection fuse in the sense of the present invention is also referred to in the prior art as a so-called “fuse link”, which can interact with a fuse holder. In this context, the fuse link can be inserted into the fuse holder.

If necessary, the fuse and/or fuse link is filled with an extinguishing agent, in particular with sand, granules and/or glass beads, in particular with the extinguishing agent being arranged in the insulating body. The insulating body can be designed as an insulating tube. The fusible conductor may in particular have been introduced axially into the insulating body. The electrical contact between the fusible conductor and the outer contact caps is established by a solder connection. In addition, the solder connection also connects the outer contact caps to the insulating body in a materially bonded manner.

The fusible link is designed to carry the full load current during operation and, in particular, to interrupt an overload current and/or short-circuit current as quickly as possible.

SMD fuses are fuse links that can be mounted on printed circuit board surfaces (SMD—Surface Mounted Device). SMD fuses therefore belong to the technical field of surface-mounted technology (SMT). In surface mount technology, printed circuit boards are generally used as the surfaces to be assembled. In particular, SMD fuses are standardized in terms of their dimensions and electrical behavior—see IEC 60127-4 (as of September 2021) in this context.

A disadvantage of the fuse known from the prior art is that in some fuses the fusible conductor is displaced and/or shifted in the insulating body during fuse production—after the fusible conductor has been inserted into the insulating body. Ultimately, the fusible conductor may not remain in its intended mounting position. When the fuse is installed, for example, the fusible conductor may come into contact with the inner wall of the insulating body and/or strike it directly. If the fusible conductor is displaced in the insulating body in this way, the switching behavior of the entire fuse changes and, in particular, no longer corresponds to the designed values. This is extremely disadvantageous, since each fuse is designed for specific values and is used in accordance with these values. A deviation from the designed values must therefore be avoided at all costs.

It is true that fuses with “displaced” fusible conductors can be rejected during the manufacturing process by means of optical inspection procedures. However, such a procedure is comparatively time-consuming and associated with high costs, especially since an optical inspection of each individual fuse must be carried out. Moreover, due to the particularly opaque insulating body, this optical inspection can only be carried out as long as the outer contact caps have not yet been fitted. However, if there is a displacement of the fusible conductor after or during the fitting of the outer contact caps, this can no longer be detected optically.

A further disadvantage of the fuse known from the prior art or of the process for manufacturing fuses known from the prior art is that the connection of the fusible conductor to the solder joint for electrical contacting of the outer contact caps is often insufficient for a permanent electrical connection. In particular, the forming of a so-called “solder ball”—a sphere made of the solder material—is required for electrical contacting between the fusible conductor and the outer contact cap, but this often cannot be adequately ensured. Thus it happens that the solder and/or the solder material leaks into the space between the outer contact cap and the insulating body and thus there is no longer sufficient solder for a sufficient permanent electrical connection between the fusible conductor and the outer contact caps.

### SUMMARY

It is therefore the task of the present invention to avoid or at least substantially reduce the aforementioned disadvantages of the prior art.

According to the invention, the aforementioned task is at least essentially solved in a fuse of the type mentioned above in that the fusible conductor is fixed in the insulating body for positionally stable arrangement by means of at least one fixing means assigned to a contact cap. The fixing means is placed on the front side of the insulating body, the fixing means being put over at least in part from the assigned contact cap.

In particular, the fixing means also covers the insulating body at least in some areas, wherein the fixing means itself is put over from the outer contact cap at least in some areas.

For the purposes of the present invention, “put over” is to be understood as both “overhanging” and “surrounding” and also “covering”. For example, a put over by means of the outer contact cap is to be interpreted in such a way that the outer contact cap covers and (in particular completely) surrounds the fixing means.

The insulating body is turned over by the outer contact caps and/or by the fixing means in particular in the area of the sheath of the insulating body, preferably in the edge-side sheath area. The insulating body may have a sheath region as well as outer front sides. Depending on the outer shape of the insulating body, the sheath region is formed in such a way that a cuboid insulating body and/or at least substantially elliptical and/or circular cross-section of the insulating body results.

Ultimately, the put over (according to the invention) is provided in such a way that the insulating body is covered on the outside by the inversion component. During the put over process, the component which puts over and the component which is put over may be in direct contact with each other, or there may be a gap between the two components. Accordingly, a seal need not be achieved by a put-over, but an at least substantially tight seal may be provided between the insulating body and the fixing means and/or between the fixing means and the outer contact cap.

In this context, it is understood that the outer contact cap may surround and, in particular, overlap not only the fixing means but also the respective front side of the insulating body.

By an indirect arrangement of the outer contact cap on the insulating body it is to be understood that between the outer contact cap and the insulating body the fixing means can be arranged. Thus, the fixing means can—from a functional point of view—be referred to as an auxiliary cap which can also—like the outer contact cap—be plugged onto the insulating body and, in particular, be adjacent to the sheath of the insulating body.

According to the invention, it is possible to fix the fusible conductor in the cavity of the insulating body in a simple manner via the at least one fixing means. Additional securing of the fixing means can be ensured via the outer contact cap, which is assigned to the respective fixing means. Thus, the outer contact cap can press the fixing means against the insulating body and/or connect the fixing means to the insulating body in a frictional and/or form-fit manner. Furthermore, the fusible conductor can be additionally fixed by placing the outer contact cap on the respective fixing means. For example, it can be provided that a further fixation of the fusible conductor can be achieved by a frictional connection between the outer contact cap and the fixing means.

Finally, the fusible conductor is electrically connected to the outer contact caps. The fusible conductor can be electrically conductively connected to the fixing means—but it does not have to be.

According to the invention, the at least one fixing means in particular ensures that the fusible conductor is securely fixed in the insulating body, in particular centered and/or axially aligned. Subsequent displacement of the fusible conductor in the insulating body until the final production of the fuse and beyond can also be avoided.

Furthermore, it is understood that the fusible conductor may be materially bonded to the at least one fixing means, the insulating body and/or the outer contact cap (if applicable, additionally). In any case, this state may be present after final assembly of the fuse. In particular, the at least one fixing means is designed in such a way that the fusible conductor can be fixed in and/or on it by frictional engagement and/or positive engagement.

Advantageously, the invention makes it possible to avoid a costly optical and manual inspection process of the manufactured fuses. Consequently, the manufacturing costs of the fuse according to the invention—despite the necessary fixing means—can be reduced, preferably by at least 10%, compared to the fuses known from the prior art—due to the elimination of discarded fuses and unnecessary costly inspections. In addition, the invention ensures in particular that damage due to defective fuses cannot occur.

Furthermore, fuses can be provided in which the fusible conductor is arranged in particular at least substantially axially and/or at least substantially centered in the insulating body. The at least one fixing means can in particular prevent the fusible conductor from leaning against or striking the inner wall of the insulating body—both immediately after manufacture and after a certain period of use.

The preferably position-stable arrangement of the fusible conductor in the insulating body is thus associated with a number of advantages.

Finally, a defined placement of the fusible conductor in the insulating body is preferably achieved via the at least one fixing means according to the invention.

The fuse according to the invention can be designed both as a so-called square (SMD) fuse—i.e. a fuse with an at least essentially cuboid insulating body and/or a fuse with an at least essentially square cross-section—and as a cylindrical fuse—i.e. a fuse with an at least essentially cylindrical insulating body and/or a fuse with an at least essentially circular cross-section.

In addition, the at least one fixing means in particular succeeds in improving the electrical contacting between the fusible conductor and the outer contact caps—in particular since the fusible conductor occupies a predetermined position in the insulating body, so that the application of an electrical contacting agent and/or a solder connection can be carried out in a targeted and reliable manner.

In a preferred embodiment, it can be provided that the fusible conductor can be arranged on and/or at a carrier means and/or carrier material, in particular applied and/or wound up. In particular, at least one glass fiber and/or a glass fiber core can be provided as the carrier means. In this context, it is understood that preferably the carrier means is fixed together with the fusible conductor by means of the at least one fixing means for positionally stable arrangement. The carrier means can extend in sections or completely over the length of the fusible conductor.

Preferably, the fusible conductor has a central areas enclosed by end areas. The end-side areas are the outer regions of the fusible conductor, which may include—but are not limited to—the outer ends and/or the outer front sides of the fusible conductor. In particular, the end-side region of the fusible conductor may correspond, for example, to at least 2% of the length of the fusible conductor in each case, preferably between 2% to 45%, more preferably between 3% to 10%. In this context, it is also understood that the lengths of the end-side areas may differ from each other. The central area may have a shape and/or configuration different from the outer-side regions.

In addition, the fusible conductor can be designed as an elongated wire.

In particular, the at least one fixing means can be regarded as a further (auxiliary) cap which, in particular, can be fitted onto the respective front side of the insulating body.

In a particularly preferred embodiment, two fixing means are provided. Each fixing means can be assigned to one front side of the insulating body and thus also to an outer contact cap. The fixing means can be of identical or different design. Particularly preferably, both end areas of the fusible conductor are fixed in one fixing means each. Thus, the fixing means can also be assigned to the end-side areas of the fusible conductor.

In addition, the fixing means can be arranged at least in some areas in the insulating body and/or outside the insulating body.

It is understood that the two fixing means do not have to be directly connected to each other. In particular, the fixing means can be spaced apart from one another in the inserted state. In addition, the fixing means can each limit the cavity of the insulating body. At least one fixing means can project into the cavity of the insulating body.

In particular, two fixing means, which can be handled separately from each other and are preferably identical in construction, can be provided.

As explained previously, the two fixing means can in particular each be assigned to an end-side region of the insulating body, preferably an end-side front side region of the insulating body. Furthermore, the insulating body can be tubular, preferably either cylindrical or cuboidal, and in particular have open front sides.

The fixing means can rest on the front sides of the insulating body. The fixing means can have an inner area projecting into the interior of the insulating body and an outer area for contact with the sheath of the insulating body.

In particular, the at least one fixing means is designed in such a way that the fusible conductor is clamped and/or fixed at least in an end-side region, preferably in the end-side front side region. Clamping is ensured in particular via a clamping connection in the fixing means. Particularly preferably, the fusible conductor is fixed with its two end-side regions in each case by a fixing means associated with the end-side region for positionally stable arrangement. The region of the fusible conductor fixed, in particular clamped, in the fixing means is also referred to below as the “fixing point”.

In this context, it is understood that a section of the fusible conductor can also protrude beyond the fixing point. Accordingly, the fixing point does not necessarily have to form the outer end of the fusible conductor.

Consequently, the particularly elongated fusible conductor can be fixed in the region of its ends and/or in the end-side regions.

In particular, the fusible conductor is at least substantially taut and/or tight between the fixing points.

Furthermore, the length of the fusible conductor can exceed the length of the insulating body or be at least substantially equal to it. Alternatively, it can be provided that the fusible conductor has a shorter length than the length of the insulating body. This is the case if the fixing point lies within the insulating body and/or projects into it.

Preferably, the fusible conductor can be arranged completely in the insulating body and extends over the entire length of the insulating body. The fusible conductor can also project over at least one front side of the insulating body. The arrangement of the fusible conductor in the insulating body and/or the fixing point can be adapted in particular to the desired electrical contacting with the outer contact caps, preferably to simplify the manufacturing process.

Preferably, the at least one fixing means is completely covered by the respectively assigned outer contact cap. Complete covering means in particular that both the region adjacent to the front side of the insulating body and the region of the fixing means adjacent to the outer surface of the insulating body are surrounded by the outer contact cap, so that—viewed from the outside—the fixing means is preferably at least substantially completely covered by the outer contact cap.

Accordingly, the outer contact cap can also protect the fixing means from external influences. In addition, the fuse can be contacted—as usual—via the outer contact caps, wherein the fixing means—which are not accessible from the outside—are provided for the positionally stable arrangement of the fusible conductor.

It is particularly preferred that the fixing means is electrically connected to the fusible conductor in each case.

In a particularly preferred embodiment, it is provided that the fixing means comprises a jacket for arrangement on the sheath surface of the insulating body. Alternatively or additionally, it can be provided that the fixing means comprises a basic side for at least partial support on the front side of the insulating body. Both the jacket of the fixing means and the basic side of the fixing means may form and/or comprise the outer region of the fixing means. They may thus be arranged outside the insulating body and, in particular, may not project into the cavity of the insulating body. The sheath of the fixing means may directly adjoin and/or abut the sheath surface of the insulating body in the inserted state. It may also be provided that a distance is provided between the sheath of the fixing means and the sheath surface of the insulating body. Accordingly, the outer contact cap can be spaced from the insulating body in the area of the sheath of the fixing means by the wall thickness of the sheath of the fixing means—when the fixing means are completely covered by the outer contact caps.

In a further preferred embodiment, the fixing means can be designed as a plug. In particular, the fixing means is designed as a lamellar plug having at least two lamellae. In addition, the plug may comprise and/or consist of an elastic material.

It is particularly preferred that the fixing means electrically connect the fusible conductor to the outer contact cap. In particular, this eliminates the need for a further contact means that would otherwise be required for contacting the fusible conductor.

The basic side of the fixing means can preferably comprise an opening and/or a recess. In particular, the opening can delimit the cavity of the insulating body and/or open into the cavity of the insulating body. Thus, the opening of the fixing means can preferably merge directly into the cavity of the insulating body. The basic side of the fixing means may rest on an end side of the insulating body. In further embodiments, it may also be provided that the basic side of the insulating body preferably projects into the insulating body at least in certain regions. The opening can be formed in such a way that a large engagement or access possibility or a large engagement or access area into the interior or into the cavity of the insulating body is created. Via this access area, for example, a comparatively simple insertion and arrangement of the fusible conductor can take place. Alternatively or additionally, further components of the fuse can be introduced into the cavity of the insulating body via this larger access area provided via the opening, for example an extinguishing agent filling. These components can thus also be introduced into the insulating body after the fusible conductor has been arranged on the insulating body, in particular without any time-consuming adaptation.

The opening can be formed in one or more parts. For example, the opening can also be separated by further components. Ultimately, the opening represents an opening area.

In a further embodiment of the invention, it is particularly preferred that at least one protrusions projects into the opening from the basic side of the fixing means for fixing and/or supporting the fusible conductor. In particular, the protrusion can be formed in a web-shaped and/or elongated manner. In particular, the protrusion is not formed circumferentially around the opening of the fixing means, but extends in particular only in a partial region from the opening edge of the fixing means into the opening of the fixing means.

The protrusion projecting into the opening area of the insulating body allows a defined arrangement and specification of the position of the fusible conductor. The protrusion thus makes it easy to ensure a positionally stable arrangement of the fusible conductor. In particular, the protrusion is arranged in such a way that the fusible conductor can be guided into the cavity of the insulating body, preferably centered.

Preferably, the protrusion does not bridge the entire width and/or diameter of the opening of the fixing beans, but extends over at least 10%, preferably between 15% to 90%, more preferably between 20% to 50%, of the maximum diameter of the opening of the fixing means. Finally, the length of the protrusion is such that the fusible conductor is at least substantially centered in the opening region of the insulating body.

Preferably, the fusible conductor is fixed to the protrusion by frictional, nonpositive and/or material locking. In particular, the fusible conductor can be clamped to the protrusion. Accordingly, the protrusion ensures that the fixing point of the fusible conductor is predetermined, which is located in the region of the protrusion.

Preferably, the protrusion has at least two bent-over legs, preferably arranged laterally on the protrusion. The legs may protrude with respect to the protrusion in the non-fixed state of the fusible conductor. The legs may further be of identical construction and may be connected to the protrusion by opposing end faces. The legs may further be integrally formed with the protrusion. In addition, the fusible conductor can be fixed to the protrusion by means of the legs, in particular enclosed between the protrusion and the legs, in particular clamped. The legs enable the fusible conductor to be fixed and/or connected to the protrusion in a cost-effective and secure manner.

In addition to the legs, a further means, such as a solder, can be provided for connecting the fusible conductor to the protrusion. The legs then continue to support the firm fixing of the fusible conductor to the protrusion.

In particular, the bent legs lie on top of each other and/or are arranged one above the other when the fuse is in use. Alternatively or additionally, the fusible conductor can be crimped, riveted and/or materially bonded, in particular soldered, to the legs of the protrusion. This enables additional secure fixing of the fusible conductor.

In particular, the legs can be used for positive and/or frictional arrangement of the fusible conductor on the protrusion. In particular, the fusible conductor and/or the end region of the fusible conductor can be clamped and/or crimped between the legs of the protrusion. For this purpose, it can be provided that, when the fusible conductor is not clamped, the legs protrude from the longitudinal sides of the insulating body, for example at a 90° angle. Ultimately—seen in cross-section—the legs and the protrusion form a U-shape. The end region of the fusible conductor can then be placed on the protrusion between the legs. The legs can then be angled and/or bent so that crimping can take place. Crimping allows the fusible conductor to be securely fixed to the protrusion. In the final assembled state, the legs of the protrusion can thus be arranged on top of each other or one above the other.

Alternatively or additionally, it may be provided that the fusible conductor is welded to the protrusion. Welding makes it possible to ensure a material connection, which is preferably inseparable and/or non-detachable, between the fusible conductor and the protrusion. In addition, the welding can also be designed in such a way that secure contacting of the fusible conductor with the fixing means and/or the outer contact cap can be ensured.

Furthermore, in another preferred embodiment, it is provided that the fusible conductor is connected to the protrusion via a solder and/or bonded to the protrusion, preferably via an electrically conductive adhesive. Ultimately, the protrusion can serve to arrange and fix the end-side region of the fusible conductor.

Furthermore, the fixing means can have at least one holding means on the basic side. The holding means can be elongated and/or web-shaped. In addition, the holding means can be connected to the protrusion to stabilize the protrusion. The protrusion can thus be designed to be permanently stable even after the fusible conductor has been arranged. Alternatively or additionally, it may be provided that the holding means projects into the opening and/or bridges the opening. Thus, the opening can be divided by the holding means, for example. The holding means itself can have at least one recess and/or breakthrough opening. This serves, for example, to enlarge the opening area and/or to save material, preferably to form the fuse in a way that conserves resources.

In particular, the fusible conductor can be guided into the cavity of the insulating body via the holding means. For example, the fixing point of the fusible conductor can be located in or on the protrusion and the fusible conductor can be guided over the holding means after the fixing point before the fusible conductor is bent and/or angled into the cavity. In particular, the holding means and the protrusion can be aligned flat with respect to each other or arranged at least substantially in the same plane. For example, the holding means as well as the protrusion may be at least substantially parallel or along the plane spanned by the plane of the insulating body. Thus, the holding means contributes to the further positionally stable arrangement of the fusible conductor and, in addition, also enables simplified guidance into the cavity of the insulating body.

The holding means can have at least one elongated slot, which is designed in particular as a recess or breakthrough opening. The slot runs in particular centrally on the holding means and preferably serves to save material or to enlarge the insertion area.

Preferably, the holding means has a guide leg projecting into the insulating body and pointing away from the basic side for guiding the fusible conductor. In particular, the fusible conductor can be bent into the cavity of the insulating body via the guide leg. The guide leg can in particular be arranged centrally on the holding means and preferably extend over at least 10%, preferably at least 20%, more preferably between 10 to 70%, of the width of the holding means and/or the maximum diameter of the opening. The guide leg can ultimately be designed in particular in such a way that no sharp angle or the like is present, so that damage to the fusible conductor can be at least substantially reliably avoided. The guide leg also further improves the positionally stable arrangement of the fusible conductor, since displacement of the fusible conductor by the guide leg can be significantly reduced. Ultimately, the guide leg can also be functionally viewed as a tongue that serves to protect the fusible conductor during handling and during application or during the manufacture of the fuse. Thus, cracks and damage to the fusible conductor during bending can be avoided starting from the protrusion of the fixing means at and/or in which the fusing point is arranged.

As explained above, the fixing means can be at least substantially identical in design. An identical design offers significant advantages with regard to manufacture and production, since two different versions of the fixing means do not have to be kept in stock for the respective intended arrangement on the front side of the insulating body. This means that errors in the production process can be avoided. For the same reason, the identical design of the outer contact caps to each other is also particularly advantageous.

In a particularly preferred embodiment, it is provided that the fixing means is designed in such a way that the sheath of the fixing means, without a contact cap fitted on it, protrudes at the end, i.e. at its free edge, at least in regions, from the outside of the insulating body, in particular from the outside of the sheath surface of the insulating body. In particular, it is understood that a further section and/or part of the fixing means can adjoin and/or lie at least substantially flush against the outer side of the insulating body, preferably against the outer surface of the insulating body, wherein a further part and/or a further section of the fixing means can be angled with respect to the outer surface of the insulating body—at least in the preassembled state without a fitted outer contact cap.

The angled section of the fixing means, which can preferably be of circumferential design, serves in particular to improve the frictionally engaged arrangement of the fixing means on the insulating body. Alternatively or additionally, it may be provided that the angled portion serves to engage behind the outer contact cap. For example, the outer contact cap may have means that can ensure rear engagement of the fixing means. For example, the outer cap may have corresponding hooks for engaging behind the angled and/or protruding part of the fixing means. Ultimately, the protruding and/or angled portion of the fixing means succeeds in ensuring a simplified fitting of the outer contact cap. In further embodiments, the outer contact cap can be fitted in such a way that it presses the angled section of the fixing means at least partially against the sheath surface of the insulating body.

Preferably, the fixing means is frictionally and/or materially connected to the insulating body, preferably by the outer contact cap. In particular, the fixing means can also be detached from the insulating body again. In further embodiments, a non-detachable connection between fixing means and insulating body may also be provided.

The fixing means can, for example, only project into the insulating body with its basic side, at least in certain areas, preferably only through the guide leg into the insulating body. The further part of the fixing means can be arranged outside the insulating body, i.e. for example rest on the front side of the insulating body and on the outer surface of the insulating body and/or adjoin the relevant surfaces. The fixing of the fusible conductor, preferably to the protrusion, can accordingly be carried out either inside or outside the insulating body via the fixing means—that is, the fixing point can be located inside or outside the insulating body.

In a further preferred embodiment, it is provided that the contact cap is connected to the fixing means and/or the insulating body in a frictionally engaged and/or form-fitted and/or substance-fitted manner. In particular, the outer contact cap is arranged in such a way that electrical contact to the fusible conductor can be ensured. In this case, the fusible conductor can be connected to the fixing means in an electrically contacting manner, but does not have to be. Further contacting aids, for example an electrical connecting means, in particular a solder connection or the like, can also be provided for contacting the fusible conductor.

Preferably, the contact cap is connected to the fixing means and/or the insulating body in a frictional and/or form-fit and/or material-fit manner. Ultimately, the contact cap can be arranged in such a way that it preferably completely covers the respective fixing means and enables external contacting of the fusible conductor arranged inside the insulating body.

The opening of the fixing means may in particular extend over at least 50%, preferably at least 70%, more preferably at least 85%, of the area of the opening of the cavity of the insulating body, in particular the maximum cross-sectional area of the cavity of the insulating body, wherein, preferably, the cross-section is parallel to the front side of the insulating body.

In particular, the fixing means and/or the outer contact cap can have and/or consist of an electrically conductive material, especially metal. Alternatively or additionally, it can be provided that an elastic plastic material and/or a non-electrically conductive material is used for the fixing means.

In addition, the cavity of the insulating body can be at least partially, preferably completely, filled with an extinguishing agent. The extinguishing agent can be introduced in particular via the opening of the fixing means. The large opening area makes it comparatively easy to introduce the extinguishing agent into the insulating body.

In addition, the outer contact caps can be materially connected to the insulating body, preferably via a connecting means. For example, the outer contact caps can be connected to the insulating body via a solder connection.

In addition, the insulating body may comprise and/or consist of an electrically insulating material, preferably glass and/or ceramic.

The fusible conductor can have as material an electrically conductive material, preferably metal, and/or consist of it. In particular, copper, nickel, steel, gold and/or silver are used as materials for the fuse conductor. In addition, the fusible conductor may also have as material a metal alloy, for example a silver and/or copper alloy.

The fusible conductor can be formed as a fusible conductor wire and/or as a fusible conductor strip. Furthermore, the fusible conductor may have an at least substantially circular and/or elliptical or an at least substantially rectangular cross-section.

In addition, the fusible conductor can be provided with constrictions by means of which a more nimble or more sluggish overload and/or short-circuit behavior can be set. The constrictions can, in particular, take the form of cross-sectional constrictions.

The extinguishing agent can in particular comprise extinguishing sand with a preferably fixed particle size distribution, which is preferably suitable for use in the fuse link. In addition, colored sands, sand and/or ceramic chips and/or glass beads can also be used as extinguishing agents.

In a further preferred embodiment, it is provided that the respective end-side region of the fusible conductor is electrically connected to the respective outer contact cap via an electrically conductive connecting means. In particular, the connecting means is arranged at least in regions in and/or on the fixing means. Preferably, the connecting means does not “creep” into the interior of the insulating body via the fixing means.

The connecting means can also be designed to make electrical contact with the fusible conductor and preferably to connect it to the outer contact cap. Thus, the connecting means may be designed as a contact means. Preferably, the connecting means can be formed as a solder connection, in particular a low-temperature solder, and/or as an, in particular lead-free, electrically conductive adhesive.

The connecting means can be designed to connect the outer contact cap to the fixing means and/or the insulating body, preferably in a substance-to-substance manner.

Furthermore, the aforementioned task is at least substantially solved by a method for producing a fuse, in particular an SMD fuse and/or a miniature fuse, according to one of the embodiments explained above. The method comprises the following method steps, which are preferably carried out in the indicated sequence (one after the other):
A) providing an insulator, a fusible conductor, at least one fixing means, and outer contact caps;
B) placing the fixing means on the front side of the insulating body;
C) inserting the fusible conductor into the insulating body by arranging it on the fixing means and fixing the fusible conductor to the respective fixing means, preferably by frictional and/or material locking, so that the fusible conductor is arranged in the insulating body in a positionally stable manner;
D) optional: crimping of the fusible conductor with the fixing means;
E) placing the outer contact caps on the insulating body and at least regionally on the fixing means, so that respective fixing means is at least regionally put over from the assigned outer contact cap.

In connection with the method according to the invention, reference may be made to the aforementioned preferred embodiments as well as advantages of the fuse, which apply in the same way to the method according to the invention, in particular without this requiring any further explicit mention. At the same time, the process features indicated below also apply in the same way to the previously explained fuse according to the invention. Accordingly, in order to avoid unnecessary repetition, reference is made to the above explanations.

Placement of the outer contact caps results in particular in electrical connection of the outer contact caps to the fixed fusible conductor, which occurs in particular after or with step E).

In a further particularly preferred embodiment, it is provided that the insulating body is filled with an extinguishing agent, in particular extinguishing sand, granules and/or glass beads, preferably after step B) and/or C) and/or before step D) and/or E) is carried out, preferably via the opening of the fixing means. Due to the enlarged and/or large opening of the fixing means, it is comparatively easy to introduce the extinguishing agent into the insulating body—both when the fusible conductor has already been introduced into the insulating body and afterwards.

The insertion of the fusible conductor in step C) can be carried out in such a way that, after step C) has been carried out and in particular after the optional step B) has been carried out, the fusible conductor is angled into the interior of the hollow body via a holding means, preferably guided via a guide leg. The protrusion of the fixing means and, in particular, the guiding along the upper side of the holding means and the guide leg make it possible to comply with a defined specification for the arrangement of the fusible conductor in a comparatively simple manner, so that the fusible conductor can preferably be arranged centered in the insulating body. Consequently, production errors in the manufacture of the fuse can be avoided, in particular in that contact of the fusible conductor in the inner wall of the insulating body can be at least substantially reliably prevented. According to the invention, the fusible conductor is introduced into the insulating body in such a way that an at least substantially tight and/or positionally stable arrangement of the fusible conductor can be ensured.

In particular, it is provided that the insulating body is not completely filled and/or filled with the extinguishing agent in the interior. Preferably, the insulating body is at least partially filled and/or filled with the extinguishing agent.

Preferably, the fusible conductor is introduced into the insulating body by means of a tool, preferably a feed needle. In particular, the fusible conductor can be inserted over the fixing means by means of the tool and fixed to the fixing means.

Preferably, the fusible conductor is first introduced via a first fixing means and guided by the tool, preferably the feed needle, to the further and/or opposite fixing means and fixed therein, in particular by frictional and/or material locking.

After the fusible conductor has been arranged in the insulating body and the fusible conductor has been fixed, preferably in a positionally stable manner, the fusible conductor can be electrically connected to the outer contact cap, preferably by introducing an electrically conductive adhesive as a connecting means between the fusible conductor and the outer contact cap.

In particular, the connecting means, preferably the electrically conductive adhesive, can be applied first, preferably so that the fusible conductor is contacted. Subsequently, the outer contact cap can be applied so that, in particular, a material bond can also be achieved between the outer contact cap and the insulating body and/or fixing means.

In addition, the outer contact cap can be placed over the insulating body, preferably over the fixing means, by overpressing, so that in particular the connecting effect by material closure between the outer contact cap and the insulating body can be dispensed with.

In particular, the fusible conductor can be arranged at least substantially centered in the insulating body, which is particularly advantageous for the behavior of the fuse.

In particular, the manufacturing process according to the invention allows a low-temperature solder to be used as the bonding agent, since preferably the bonding agent can no longer penetrate the entire assembly space in the liquid state, especially during reflow.

In a further preferred embodiment, it can be provided that in process step C) the at least two legs projecting laterally from the protrusion are bent over in such a way that the legs lie on top of one another and/or on top of one another and the fusible conductor is fixed between the legs and the protrusion, in particular with the legs being crimped and/or in particular with the fusible conductor and the legs being connected to one another by a material bond, in particular by soldering. Fixing the fusible conductor in this way provides a secure, permanent and stable contact for the fusible conductor in the fuse. It also makes it possible to dispense with soldering if necessary, although this can of course be provided in addition.

Furthermore, it is understood that any intermediate intervals and individual values are included in the above-mentioned intervals and range limits and are to be regarded as disclosed as essential to the invention, even if these intermediate intervals and individual values are not specifically indicated.

Further features, advantages and possible applications of the present invention will be apparent from the following description of examples of embodiments based on the drawing and the drawing itself. In this context, all the features described and/or illustrated constitute the subject-matter of the present invention, either individually or in any combination, irrespective of their summary in the claims or their relation back.

### BRIEF DESCRIPTION OF THE DRAWINGS

It shows:

FIG. 1 is a perspective view of a schematically illustrated fuse according to the invention,

FIG. 2 is a perspective view of the fuse shown schematically in FIG. 1 without outer contact caps in a first state,

FIG. 3 is a sectional view of the components shown in FIG. 2,

FIG. 4 is a perspective view of the fuse shown schematically in FIG. 1 without outer contact caps in a second state,

FIG. 5 is a sectional view of the components shown in FIG. 4,

FIG. 6 is a schematic perspective view of a further embodiment of a fuse according to the invention without outer contact caps in a first state,

FIG. 7 is a sectional view of the components shown in FIG. 6,

FIG. 8 is a schematic perspective view of one of the fuses shown in FIG. 6 without outer contact caps in a second state,

FIG. 9 is a sectional view of the components shown in FIG. 8,

FIG. 10 is a schematic perspective view of a further embodiment of a fuse according to the invention without outer contact caps in a first state,

FIG. 11 is a sectional view of the components shown in FIG. 10,

FIG. 12 is a schematic perspective view of the fuse shown in FIG. 10 without outer contact caps in a second state,

FIG. 13 is a sectional view of the components shown in FIG. 12,

FIG. 14 is an illustration of a schematically shown process sequence according to the invention for producing a fuse, and

FIG. 15 is a schematic representation of a fusible conductor.

### DETAILED DESCRIPTION

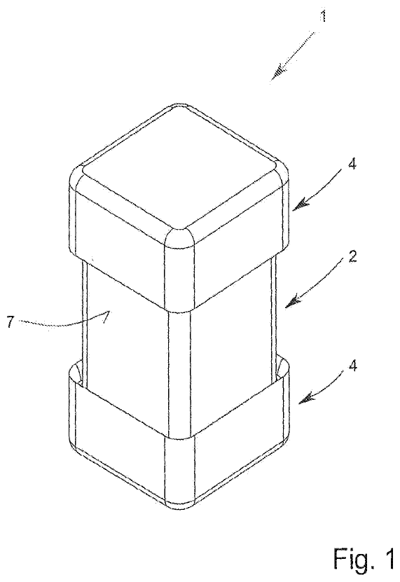

FIG. 1 shows a schematic perspective view of a fuse 1. The fuse 1 can be used in particular as an SMD fuse or miniature fuse.

In the following, a fuse 1 is understood to mean in particular a fuse link which can be inserted into a fuse holder not shown. However, it is understood that the following statements apply in particular to the fuse link.

The fuse holder may include a fuse base, such as a base, and a fuse link carrier, such as a screw or countersunk cap. The fuse base may be installed in a device to be protected. The fuse link carrier may receive the fuse link or fuse 1 for easy replacement.

In the case of an SMD fuse 1, it can also be provided that the fuse 1 can be firmly connected to a printed circuit board not shown in more detail.

FIG. 1 shows that the fuse 1 has an insulating body 2.

The insulating body 2 has an at least essentially cuboidal basic structure, as shown schematically in FIG. 1. Alternatively or additionally, insulating bodies 2 can also be provided that are at least essentially cylindrical or have a different geometrical design.

A fusible conductor 3 is arranged in the insulating body 2, as shown schematically in FIG. 3. The fusible conductor 3 is arranged and/or fastened within, preferably in the central region in the insulating body 2, preferably at least substantially centered.

The fuse 1 further comprises outer contact caps 4, as schematically shown in FIG. 1. The outer contact caps 4 are electrically connected to the fusible conductor 3. In addition, the respective outer contact cap 4 is placed on the insulating body 2, in particular on the front sides 5 and 6 of the insulating body 2, preferably by overpressing.

The insulating body 2 comprises front sides 5, 6 and a sheath surface 7. The front sides 5, 6 of the insulating body 2 are in particular at least substantially open.

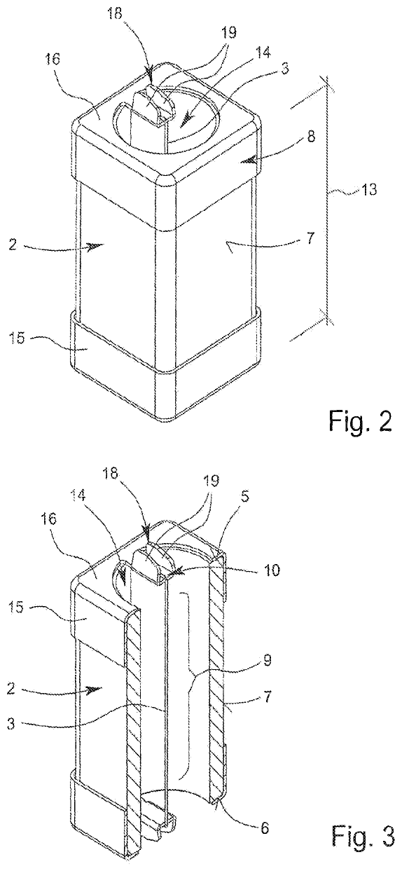

FIG. 2 shows that the fusible conductor 3 is fixed by means of at least one fixing means 8, so that the fusible conductor 3 is arranged in a stable position, preferably at least substantially centered, in the insulating body 2 via the fixing means 8.

Finally, the fusible conductor 3 is arranged in a stable position in the insulating body 2 by means of the at least one fixing means 8. The fixing means 8 is placed on the front side of the insulating body 2, as shown schematically in FIGS. 2 and 3.

FIG. 1 shows that the fixing means 8 is at least partially—in the example shown in FIG. 1 completely—put over the assigned outer contact cap 4. FIG. 1 shows that the fixing means 8 is turned over in such a way that the fixing means 8 is covered and/or overlapped on the outside by the contact cap 4 in the put-over area.

FIG. 3 shows that the fixing means 8 itself covers the insulating body 2 in the end regions of the insulating body 2. In the embodiment example shown in FIG. 3, it is provided that the fixing means 8 acts as an auxiliary cap which is placed on the respective front side 5, 6 of the insulating body 2. In the embodiment example shown in FIG. 3, the fixing means 8 does not comprise a region and/or section that projects into the insulating body 2. In further embodiments, such as those also shown in FIG. 11, for example, a region and/or section of the fixing means 8 projects into the insulating body 2. However, the fixing means 8 overlaps the insulating body 2 on the outside, preferably on all sides.

The fusible conductor 3 can be frictionally connected, positively connected and/or materially connected to the fixing means 8. In the embodiment example shown in FIG. 5, the fusible conductor is frictionally connected to the fixing means 8 and, in particular, clamped in corresponding clamping means.

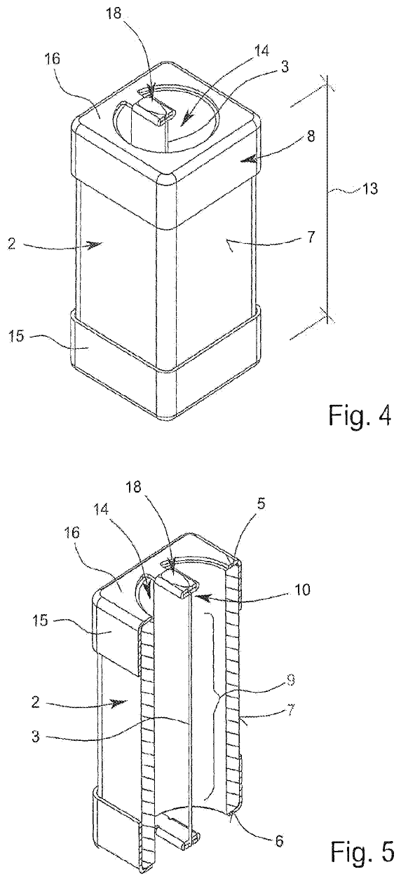

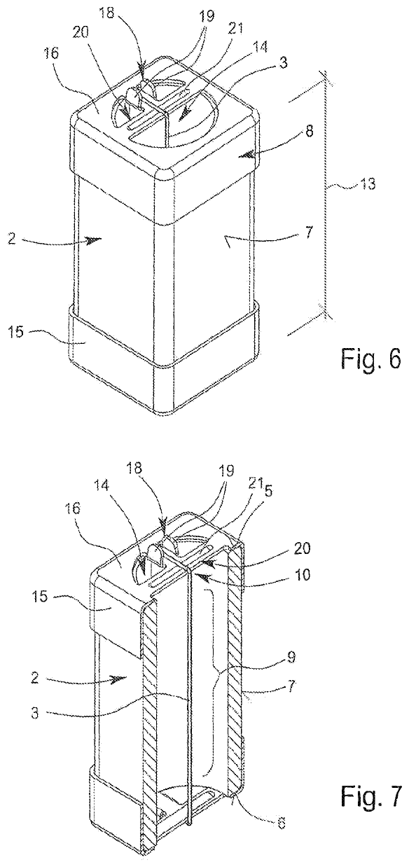

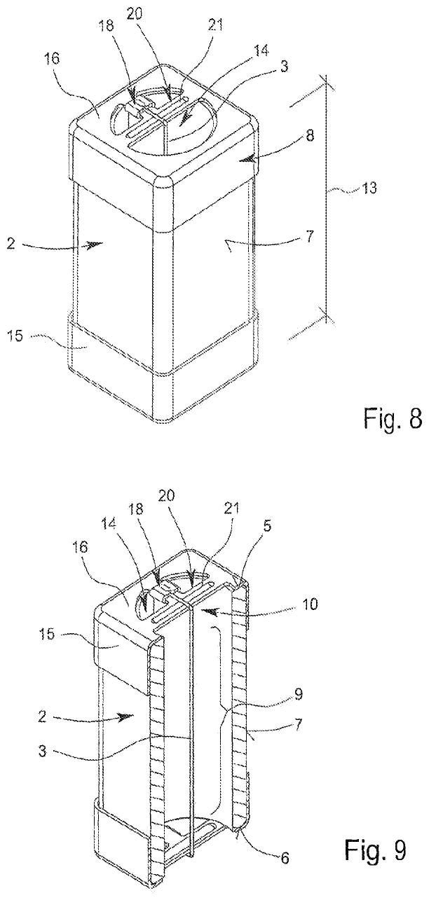

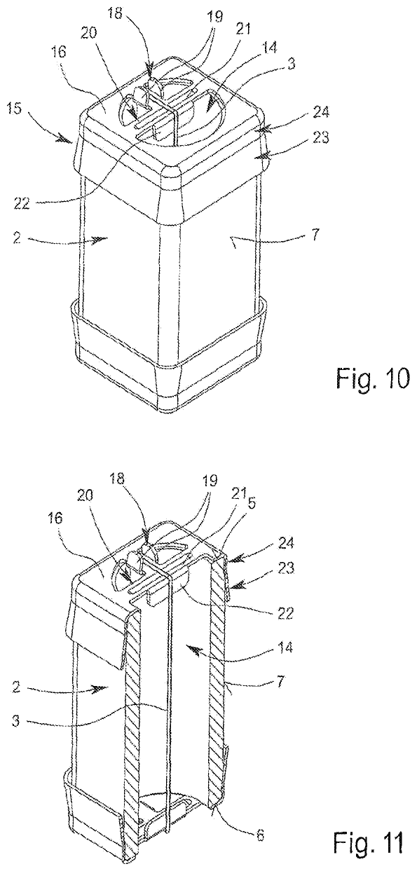

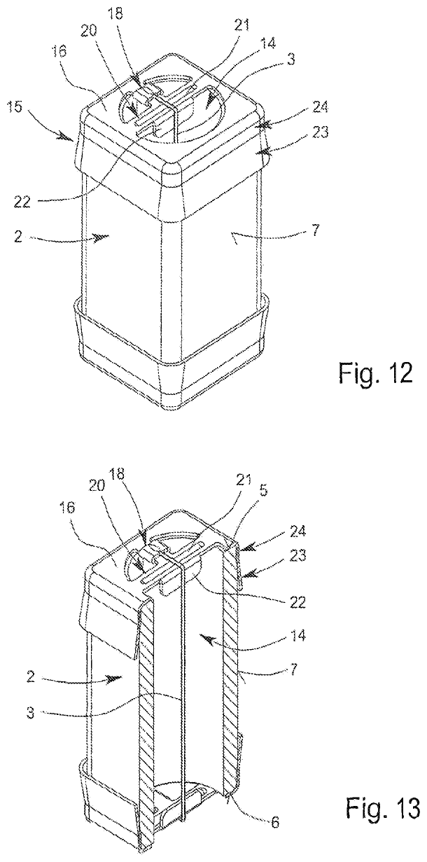

FIGS. 2 and 3 show a pre-assembled state of the fuse 1 in which the fusible conductor 3 is not yet permanently connected to the fixing means 8. FIGS. 4 and 5, on the other hand, show the connected state. This differs in that crimping has already been carried out, as will be explained below. The same difference also applies to FIGS. 6 and 7, which show the pre-assembled state of the fuse, with the corresponding FIGS. 8 and 9 illustrating the “final state” or the assembled state of the fixing means 8. The same applies to FIGS. 10 and 11, in which the fusible conductor is not yet crimped to the fixing means 8. FIGS. 12 and 13 show the crimped state of the fixing means 8 shown in FIGS. 10 and 11.

FIGS. 3, 5, 7, 9 and 11 illustrate that two fixing means 8 are provided which, in particular, are at least substantially identical in construction. FIG. 1 shows that two outer contact caps 4 of identical design are provided.

Each fixing means 8 may be associated with a front end portion of the insulating body 2 and an outer contact cap 4.

Not shown is that provision can be made for the fusible conductor 3 to be connected to the fixing means 8, for example, by a material bond or by a form fit.

The fusible conductor 3 comprises a central area 9, which is enclosed by the end areas 10, 11. The central area 9 is located—in the inserted state of the fusible conductor 3—inside the insulating body 2. The end areas 10, 11 of the fusible conductor 3 can have the fixing point.

In this context, it is understood that the end areas 10, 11 do not necessarily have to be fixed with their outer ends, but ultimately form an outer region of the fusible conductor 3.

Accordingly, the fusible conductor 3 is arranged, held or fixed in the region of at least one area 10, 11 in at least one fixing means 8.

The fusible conductor 3, which has an elongated shape, can be in the form of a fusible wire or fusible band, as shown schematically in FIG. 15.

It is not shown that the fusible conductor 3 can be arranged on and/or at a carrier means or carrier material, in particular applied and/or wound up. At least one glass fiber and/or one glass fiber core can be provided as a carrier means. The carrier means can be fixed together with the fusible conductor 3 at least frictionally in the fixing means 8. The carrier means can extend in sections or completely over the length 12 of the fusible conductor 3.

In the illustrated embodiments, it is shown that the length 12 of the fusible conductor 3 (in the “extended” or non-bent state) exceeds the length 13 of the insulating body 2.

In further embodiments, the length 12 of the fusible conductor 3 may be less than or equal to the length 13 of the insulating body 2.

Furthermore, it is understood that the fusible conductor 3 can also protrude beyond the fixed points and/or the fixing point or be angled relative thereto in the clamped state in the fixing means 8. Accordingly, the fixing point is located in the respective end-side area 10, 11.

The fusible conductor 3 extends over a cavity 14 of the insulating body 2. The at least one fixing means 8 bounds the cavity 14 at the front sides.

In the embodiment shown in FIG. 7, it is provided that the fixing means 8 is electrically conductively connected to the fusible conductor 3 in each case. In further embodiments, it may be sufficient if the fusible conductor 3 is connected to the outer contact caps 4 in an electrically contacting manner. This is particularly the case if the auxiliary cap and/or the fixing means 8 is formed from an electrically insulating material. However, it is preferred that the fixing means 8 has or consists of an electrically conductive material, in particular metal. In this way, simplified contacting between the outer contact cap 4 and the fusible conductor can be made possible via the fixing means 8, since it is then sufficient to contact the fixing means 8 in order to contact the fusible conductor, so that the outer contact cap 4 does not necessarily have to abut directly against the fusible conductor 3. Further necessary connecting means, such as a solder and/or an electrically conductive adhesive, for contacting the fusible conductor 3 can also be omitted. In principle, however, it is also possible for the outer contact cap 4 to be electrically connected to the fusible conductor 3 via a connecting means—for example a solder and/or an electrically conductive adhesive.

FIG. 5 shows that the fixing means 8 has a jacket 15 which is provided for arrangement on the sheath surface 7 of the insulating body 2. The jacket 15 does not adjoin the interior of the insulating body 2, but adjoins the outer surface of the sheath 7 of the insulating body 2. For this purpose, the jacket has four jacket sides arranged at right angles to each other. In addition, FIG. 5 shows that the fixing means 8 comprises a basic or front side 16 which is provided for at least partial support on the respective front side 5, 6 of the insulating body 2.

The basic side 16 can be designed in such a way that it projects into the interior of the insulating body 2. In FIG. 5, however, it is provided that the basic side 16 does not project into the interior of the insulating body 2, but merely adjoins and/or bounds the cavity 14 of the insulating body 2. In the embodiment example shown in FIG. 13, on the other hand, it is provided that the basic side 16 projects with a section into the cavity 14 (and thus into the insulating body 2).

FIG. 5 further shows that the basic side 16 of the fixing means 8 comprises an opening 17. The opening 17 is designed in particular as an aperture in the basic side 16. The opening 17 can be formed in one piece or in several pieces. In FIG. 8, for example, a multipart design of the opening 17 is shown. Ultimately, further components of the fuse 1 can be introduced into the insulating body 2 via the opening 17, such as an extinguishing agent filling. According to the invention, it is possible to provide a particularly large area of the opening 17. The opening 17 can open into and/or delimit the cavity 14 of the insulating body 2.

FIG. 4 shows that at least one protrusion 18 projects into and/or is arranged in the opening 17. The protrusion 18 is associated with the basic side 16 of the fixing means 8. In the embodiment example shown in FIG. 4, it is provided that the protrusion 18 is formed in a web-shaped and/or elongated manner. The protrusion 18 does not completely surround the edge of the opening 17. In this case, the length of the protrusion 18 can in particular be between 10% to 80%, preferably between 15% to 50%, of the maximum opening width of the opening 17. Ultimately, the protrusion 18 projects from the surrounding material of the basic side 16 into the area of the opening 17. The fusible conductor 3 can be guided into the interior of the insulating body 2 via the protrusion 18. The length of the protrusion 18 can also determine how far the fusible conductor 3 is guided into the interior. Accordingly, it is particularly advantageous if the protrusion 18 projects at least substantially into the opening 17 in such a way that a substantially centered arrangement of the fusible conductor 3 in the insulating body 2 can be ensured.

The fixing point of the fusible conductor 3 may in particular be provided on and/or at the protrusion 18.

Accordingly, the fusible conductor 3 can be fixed to the protrusion 18 in a frictionally engaged, force-locking and/or material-locking manner, preferably clamped. In the embodiment example shown in FIG. 5, it is provided that the fusible conductor 3 is clamped with its end-side regions 10, 11 in and/or on the protrusion 18.

In each of the illustrated embodiments, the protrusion 18 is provided with legs 19. Ultimately, two legs 19 arranged on opposite sides of the protrusion are provided in the illustrated embodiments.

Furthermore, three different variants of the fixing means 8 are ultimately shown in the illustrated embodiment examples. FIGS. 2 and 3, 6 and 7 and 10 and 11 each show a first state in which a pre-assembled state is depicted, wherein in this state the legs 19 have not yet been bent over. For clamping the fusible conductor 3, it can then be provided that the legs 19 are bent over in such a way that the fusible conductor 3 is crimped to the protrusion 18. This is illustrated in each of the corresponding FIGS. 4 and 5; 8 and 9; 12 and 13. In these illustrations, the legs 19 are arranged over or on top of each other. Thus, the fusible conductor 3 is firmly connected to the protrusion 18 in its end areas 10, 11.

The legs 19 protrude laterally from the protrusion 18 and are arranged with their end faces laterally opposite on the protrusion 18.

In particular, the fusible conductor 3 is fixed to the protrusion 18 by means of the legs 19. The fusible conductor 3 is further enclosed, in particular clamped, between the protrusion 18 and the legs 19. In further embodiments, the fusible conductor 3 may be riveted and/or materially connected, in particular soldered, to the legs 19 of the protrusion 18.

It is not shown in more detail that the fusible conductor 3 can also be welded to the protrusion 18 and/or connected via a solder. It is also not shown that in further embodiments the fusible conductor 3 can—if necessary additionally—be bonded with an electrically conductive adhesive.

The embodiments according to FIGS. 6 and 7 as well as 10 and 11 differ from the embodiment shown in FIGS. 2 and 3 in that a holding means 20 is provided. The holding means 20 is provided on the basic side 16. In particular, the holding means 20 serves to stabilize the protrusion 18. In FIGS. 6 to 13, it is shown that the holding means 20 is directly connected to the protrusion 18. In particular, the holding means 20 extends over the entire opening width of the opening 17. The holding means 20 may comprise an elongated slot 21. Further, the holding means 20 may divide or subdivide the opening 17 into a plurality of sections or sub-openings. Ultimately, the holding means 20 may bridge the opening 17. As shown in the embodiments illustrated in FIGS. 6 to 13, the fusible conductor 3 is guided into the insulating body 2 via the holding means 20. In this case, it is provided that the fusible conductor 3 is fixed to the protrusion 18 with its fixing point and is then guided into the cavity 14 via the holding means 20. Accordingly, in addition to stabilizing the protrusion 18, the holding means 20 also serves to guide the fusible conductor 3 in a defined manner and thus simplifies the positionally stable, in particular centered, arrangement of the fusible conductor 3 in the insulating body 2.

In the embodiment according to FIGS. 10 to 13, it is provided that the holding means 20 has a guide leg 22. The guide leg 22 can extend over at least 30%, preferably between 30% to 70% of the width of the holding means 20 and/or the opening width of the opening 17. The fusible conductor 3 can be guided into the interior and/or cavity 14 of the insulating body 2 via the guide leg 22. In this case, the guide leg 22 can also be arranged on the inside of the insulating body 2 and ultimately project into the cavity 14. The guide leg 22 can ensure that damage to the fusible conductor 3 can be at least substantially prevented during bending. For this purpose, the guide leg 22 can be bent at a rounded angle at the transition to the holding means 20 and thus also ensure a rounded bending of the fusible conductor 3. Ultimately, there is no sharp angle between guide leg 22 and holding means 20.

In the embodiment according to FIGS. 10 to 13, it is further shown that the fixing means 8 is designed in such a way that the jacket 15 of the fixing means 8 without the contact cap 4 fitted—i.e. in a preassembled state—protrudes at the end opposite the outside of the insulating body 2 at least in some areas, preferably circumferentially. In addition, FIGS. 10 and 11 show that the jacket 15 of the fixing means 8 comprises a further region 24, in particular a circumferential region 24, which rests flush against the insulating body 2, in particular against the sheath surface 7 of the insulating body 2. The flush part 24 of the jacket 15 of the fixing means 8 can face the respective front side 5, 6 of the insulating body 2. The angled region 23 of the jacket 15 of the insulating body 2 can be formed in particular for improved frictional engagement of the contact cap 4 to the insulating body 2 and/or serves to engage behind the outer contact caps 4, which are placed on the fixing means 8 and on the insulating body 2—in the respective front side end region.

The fixing means 8 may ultimately be frictionally and/or materially connected to the insulating body 2, preferably by the outer contact cap 4.

The outer contact cap 4, in turn, can be connected to the fixing means 8 and/or the insulating body 2 in a frictional and/or form-fit and/or material-fit manner. Ultimately, the connection of the individual components is selected depending on the respective embodiment. Also, the field of application of the fuse 1 may have an influence on the connection of the components to each other. In this context, it is understood that individual connection methods can also be combined with one another. For example, in addition to a frictional connection, there can also be a material connection in particular, if this is required by the application.

In the embodiments shown, both the fixing means 8 and the contact cap 4 have and/or consist of an electrically conductive material, in particular metal. The outer contact cap 4 can be in direct contact with the fusible conductor 3 in the mounted state. Alternatively or additionally, it can also be provided that in the final assembled state of the fuse 1 there is a distance between the fusible conductor 3, in particular the end-side areas 10, 11 of the fusible conductor 3, and the inside of the outer contact cap 4. Then the outer contact cap 4 can be electrically connected to the fusible conductor 3 either by contacting it via the respective fixing means 8 and/or by introducing a connecting means, for example a conductive adhesive or the like. This is particularly advantageous if the fixing means 8 is formed from an electrically insulating material, for example an elastic plastic.

A solder joint and/or a conductive, in particular lead-free, adhesive can be provided as a connecting means.

In addition, the connecting means may provide a material closure between the outer contact cap 4 and the fixing means 8 and/or the insulating body 2.

In particular, the connecting means does not penetrate or creep into the inner region of the insulating body 2.

It is not shown in more detail that the cavity 14 of the insulating body 2 is at least partially filled with an extinguishing agent, in particular extinguishing sand, granules and/or glass beads. The extinguishing agent can in particular be introduced into the insulating body 2 via the opening 17.

The fixing means 8 can be connected to the insulating body 2 in a frictionally engaged, materially engaged and/or form-fit manner. Ultimately, the fixing means 8 is designed in particular to be connected, preferably releasably, to the insulating body 2. Thus, in further embodiments not shown, the fixing means 8 can also be clamped in the insulating body 2 at least in certain areas.

It is not shown in more detail that the insulating body 2 comprises and/or consists of an electrically insulating material, in particular a material comprising a glass and/or ceramic compound.

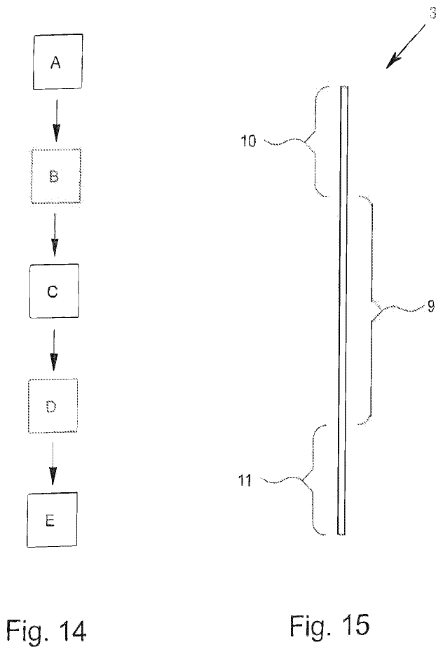

FIG. 14 shows a schematic sequence of a process for manufacturing a fuse 1. In particular, the process is used to manufacture a fuse 1 according to one of the embodiments described above. Thus, the production of an SMD fuse and/or a miniature fuse can take place.

FIG. 14 shows the process steps A to E, which are carried out in sequence in the schematic sequence shown. In this context, it is understood that a modified sequence of individual process steps—at least with regard to the time sequence—can also be provided.

In the embodiment example shown in FIG. 14, step A provides that an insulating body 2, a fusible conductor 3, at least one fixing means 8 and outer contact caps 4 are provided.

Furthermore, in step B) it is provided that the at least one fixing means 8, preferably both fixing means 8, are placed on the front sides 5, 6 of the insulating body 2. Subsequently, in step C), the insertion of the fusible conductor 3 into the insulating body 2 is effected by arrangement on the fixing means 8 and, preferably by frictional and/or material locking, fixing of the fusible conductor 3 on the fixing means 8, so that the fusible conductor 3 is arranged in the insulating body 2 in a positionally stable manner.

Step D) is provided as an option. In step D), the fusible conductor 3 in particular is crimped to the fixing means 8. Crimping can be performed in particular by placing the legs 19 of the protrusion 18 on one another and then crimping them, so that the fusible conductor 3 is connected by its end areas 10, 11 to the respective protrusion 18. In this way, the crimping can be used to specify the fixing point of the fusible conductor 3.

In step E), the outer contact caps 4 are then placed on the insulating body 2 and at least partially on the fixing means 8. The contact cap 4 is placed over the fixing means 8 at least in certain areas. In particular, the respective fixing means 8 is completely turned over and/or covered by the contact cap 4. This means that the fixing means 8 is no longer accessible from the outside.

Placing the outer contact caps 4 results in particular in electrical contacting between the fusible conductor 3 and the outer contact caps 4. The contacting can take place, for example, by direct contacting of the fusible conductor 3 or via indirect contacting via the respective fixing means 8.

It is preferably provided that in process step C) the at least two legs 19 projecting laterally from the protrusion 18 are bent over in such a way that the legs 19 lie on top of one another and/or on top of one another and the fusible conductor 3 is fixed between the legs 19 and the protrusion 18. In addition to crimping, it is also possible to provide for the fusible conductor 3 and the legs 19 to be joined to one another by material bonding, in particular by soldering.

After or before the insertion of the fusible conductor 3 into the insulating body 2, the insulating body 2 can be filled with an extinguishing agent, preferably extinguishing sand, in particular in the inner central region. Accordingly, the insulating body 2 can be filled with extinguishing agent, preferably partially, in particular after step C and/or after step D) and/or before step E) is carried out. In addition to extinguishing sand, granules and/or glass beads are also provided in further embodiments.

### LIST OF REFERENCE SIGNS

1 Fuse
2 Insulating body
3 Fusible conductor
4 Outer contact cap
5 Front side of 2
6 Front side of 2
7 Sheath surface from 2
8 Fixing means
9 Central area from 3
10 End area of 3
11 End area of 3
12 Length from 3
13 Length from 2
14 Cavity
15 Jacket from 8
16 Basic side
17 Opening
18 Protrusion
19 Leg
20 Holding means
21 Slot
22 Guide leg
23 Angled part of 15
24 Flush part of 15

1. A fuse, in particular a surface mounted device (SMD) fuse and/or a miniature fuse, the fuse comprising:
an insulating body having a cavity;
a fusible conductor arranged in the insulating body; and
outer contact caps placed on a front side of the insulating body and electrically connected to the fusible conductor;
wherein the fusible conductor is fixed for positionally stable arrangement in the insulating body by means of at least one fixing means assigned to a contact cap;
wherein the fixing means is placed on the front side of the insulating body; and
wherein the fixing means is put over at least in regions from the assigned contact cap.

2. The fuse according to claim 1, wherein at least two fixing means are provided.

3. The fuse according to claim 1, wherein the fixing means is completely covered by the assigned contact cap.

4. The fuse according to claim 1, wherein the fixing means is electrically connected to the fusible conductor.

5. The fuse according to claim 1, wherein the fixing means has a jacket for bearing at least in regions on a sheath surface of the insulating body and/or wherein the fixing means has a basic side for bearing at least in regions on the front side of the insulating body.

6. The fuse according to claim 5, wherein the basic side of the fixing means has an opening, in particular wherein the opening bounds the cavity of the insulating body and/or opens into the cavity of the insulating body.

7. The fuse according to claim 6, wherein at least one, in particular web-shaped and/or elongated, protrusion projects into the opening from the basic side of the fixing means for fixing and/or supporting the fusible conductor.

8. The fuse according to claim 7, wherein the fusible conductor is fixed to the protrusion in a frictionally engaged, force-locking and/or substance-locking manner, preferably clamped; and/or
wherein the protrusion has at least two bent-over legs, preferably arranged laterally on the protrusion, and the fusible conductor is fixed on the protrusion by means of the legs, in particular being enclosed between the protrusion and the legs, in particular clamped, in particular the bent-over legs lying on top of one another and/or being arranged one above the other and/or in particular the fusible conductor being crimped, riveted and/or materially connected, in particular soldered, to the legs of the protrusion; and/or
wherein the fusible conductor is welded to the protrusion; and/or
wherein the fusible conductor is connected to the protrusion via a solder and/or bonded to the protrusion, preferably via an electrically conductive adhesive.

9. The fuse according to claim 7, wherein the fixing means has at least one, in particular web-shaped and/or elongated, holding means on the basic side, in particular wherein the holding means is connected to the protrusion for stabilizing the protrusion and/or in particular wherein the holding means projects into the opening and/or bridges the opening and/or in particular wherein the fusible conductor is guided into the insulating body at least in regions via the holding means.

10. The fuse according to claim 9, wherein the holding means has at least one elongated slot.

11. The fuse according to claim 9, wherein the holding means has a guide leg projecting into the insulating body and pointing away from the basic side for guiding the fusible conductor, in particular the fusible conductor being bent over the guide leg into the cavity of the insulating body, preferably in a rounded manner.

12. The fuse according to claim 1, wherein the fixing means are designed to be at least substantially identical in construction to one another and/or wherein the outer contact caps are designed to be at least substantially identical in construction to one another.

13. The fuse according to claim 5, wherein the fixing means is designed in such a way that the jacket of the fixing means, without a contact cap fitted on it, protrudes at its free edge on the end side, at least in regions, with respect to the outside of the insulating body.

14. The fuse according to claim 1, wherein the fixing means is connected to the insulating body in a frictionally engaged and/or materially engaged manner, preferably by the contact cap.

15. The fuse according to claim 1, wherein the contact cap is connected to the fixing means and/or the insulating body in a frictional and/or positive and/or material-locking manner.

16. The fuse according to claim 1, wherein the fixing means and/or the contact cap has and/or consists of an electrically conductive material, in particular metal.

17. The fuse according to claim 1, wherein the cavity of the insulating body is at least partially filled with an extinguishing agent.

18. A method for producing a fuse, in particular a surface mounted device (SMD) fuse and/or a miniature fuse, according to claim 1, the method comprising the following method steps, which are preferably carried out in succession:
A) providing an insulating body, a fusible conductor, at least one fixing means and outer contact caps;
B) placing the fixing means on the front sides of the insulating body;
C) insertion of the fusible conductor into the insulating body by arrangement on the fixing means and, preferably by frictional and/or material locking, fixing of the fusible conductor on the fixing means so that the fusible conductor is arranged in the insulating body in a positionally stable manner;
D) optional: crimping of the fusible conductor with the fixing means;
E) placing the outer contact caps on the insulating body and at least regionally on the fixing means, so that each fixing means is put over at least regionally from the contact cap.

19. The method according to claim 18, wherein the insulating body is filled with an extinguishing agent, in particular extinguishing sand, granules and/or glass beads, preferably after step B) and/or C) and/or before step D) and/or E) is carried out, preferably via an opening of the fixing means.

20. The method according to claim 18, wherein in method step C) it is provided that at least two legs projecting laterally from a protrusion are bent over in such a way that the legs lie upon each other and/or on top of one another and the fusible conductor is fixed between the legs and the protrusion, in particular with the legs being crimped and/or, in particular, with the fusible conductor and the legs being connected to one another by a material bond, in particular by soldering.
